(19) United States
(12) Patent Application Publication
(10) Pub. No.: US 2013/0187847 A1
(43) Pub. Date: Jul. 25, 2013

(54) IN-CAR EYE CONTROL METHOD

(71) Applicants: Chia-Chun TSOU, New Taipei City (TW); Chih-Heng FANG, New Taipei City (TW); Po-Tsung LIN, New Taipei City (TW)

(72) Inventors: Chia-Chun TSOU, New Taipei City (TW); Chih-Heng FANG, New Taipei City (TW); Po-Tsung LIN, New Taipei City (TW)

(73) Assignee: UTECHZONE CO., LTD., New Taipei City (TW)

(21) Appl. No.: 13/594,461

(22) Filed: Aug. 24, 2012

(30) Foreign Application Priority Data
Jan. 19, 2012 (TW) 101102170

(51) Int. Cl. G06F 3/01

(52) U.S. Cl. 345/156

(57) ABSTRACT

An in-car eye control method is provided to monitor a car driver's eye movements, thereby allowing the driver to communicate with people outside the car or control in-car equipment. The in-car eye control device essentially includes an image capturing unit for capturing an image of the driver, an processing unit for performing operations on the image taken, an eye determination unit for monitoring the driver's eye movements and generating an eye control instruction, and a system operation unit for executing a system process according to the eye control instruction. Thus, the in-car eye control method provides a diversity of communication or control solutions.

### BACKGROUND OF THE INVENTION

1. Technical Field

The present invention relates to an electronic device for use in a car. More particularly, the present invention relates to an in-car eye control method which enables control by eye movements.

2. Description of Related Art

Recently, more and more attention has been placed on driving safety. As is well known, many traffic accidents are associated with drivers' incorrect operations which are typically caused by fatigue due to insufficient sleep, driving for long hours without taking a rest, or driving under the influence. Once a driver is absentminded, distracted, or in poor mental condition, car accidents are likely to occur. To address such safety issues, a good number of technical solutions have been proposed. China Patent Application No. 200910310326.3, for example, discloses a driver monitoring apparatus and method which involve capturing images, detecting a driver's eye area and how the driver's hands are placed on the steering wheel, and thereby determining whether the driver's eyes are open or are closed because of tiredness and whether the driver's hands are placed on the correct positions on the steering wheel. U.S. Pat. No. 8,045,766, entitled “Device, program, and method for determining sleepiness”, provides another kind of solution. More specifically, a driver's facial image is taken and then calculated by a specific algorithm. When the driver is found to be sleepy, an air supplying device and a seatbelt vibrator are activated to prevent the driver from sleeping. If necessary, a brake controller will be activated to provide further warning.

In addition, U.S. Pat. No. 6,842,670, entitled “Eye-tracking driving system”, provides an eye-tracking system including a pair of specially designed eyeglasses. Equipped with a camera for taking images of the wearer's eyes, the eyeglasses enable a mobility challenged person to control a wheelchair by eye movements.

The aforementioned eye movement-based techniques are designed either for detecting a driver's condition and providing necessary warning or for controlling a wheelchair. Hence, despite the fact that these techniques are workable and are effective to some degree, they are limited in function. The foregoing techniques do not allow a driver to control car equipment or send out messages by eye movements.

### SUMMARY OF THE INVENTION

In view of the above, the present invention discloses an in-car eye control method. By monitoring the variation of a driver's eye movements, the disclosed in-car eye control method allow the driver to operate a car radio and other in-car equipment or make phone calls in order to communicate with people outside the car.

It is another objective of the present invention to provide an in-car eye control method that can be used to send out distress signals. Thus, when a driver needs to seek immediate help, as in the case of a hijack, robbery, etc., the driver only has to make a specific eye movement, and the device of the present invention will automatically send out a distress signal. As such, the present invention advantageously features easy operation, rapid action, and unnoticeable alarm.

The disclosed in-car eye control device essentially includes an image capturing unit, a processing unit, and a state feedback unit. The image capturing unit is configured for capturing a head image of a driver. The processing unit includes an image processing unit for performing image processing on the head image and thereby obtaining an eye image; an eye determination unit for performing operations on the eye image, obtaining an eye characteristic parameter, and generating an eye control instruction by comparing the eye characteristic parameter with a system control condition; a system operation unit for executing a system process according to the eye control instruction; and a communication processing unit connected to the system operation unit and configured for transmitting messages or data to the outside of the car according to the eye control instruction or the system process. The state feedback unit can send out an alert signal indicating successful or failed execution of the system process according to the system process, thereby alerting the driver to the execution states of the various operations of the device of the present invention.

### BRIEF DESCRIPTION OF THE SEVERAL VIEWS OF THE DRAWINGS

The objectives, technical contents, and features of the present invention will be best understood by referring to the following detailed description of a preferred embodiment in conjunction with the accompanying drawings, in which:

FIG. 1 is a structural diagram of the device of the present invention;

FIG. 2 schematically shows how the device of the present invention is installed;

FIG. 3 schematically shows how an eye image is obtained;

FIG. 4 schematically shows a first eye movement;

FIG. 5 schematically shows a second eye movement;

FIG. 6 is the first half of the flowchart of the method of the present invention; and

FIG. 7 is the second half of the flowchart of the method of the present invention.

### DETAILED DESCRIPTION OF THE EMBODIMENTS OF THE INVENTION

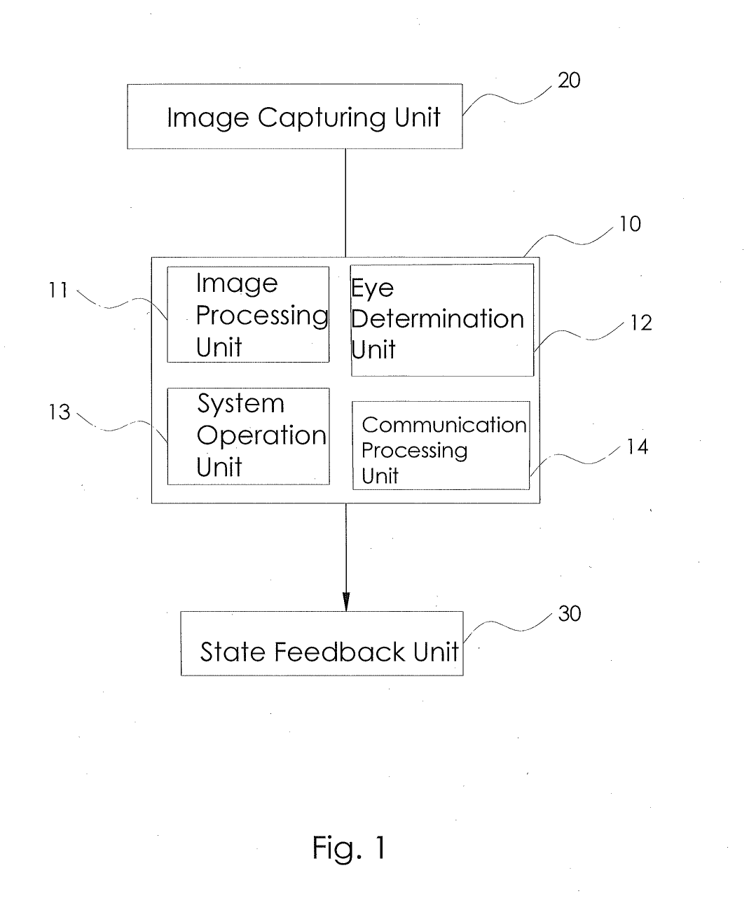

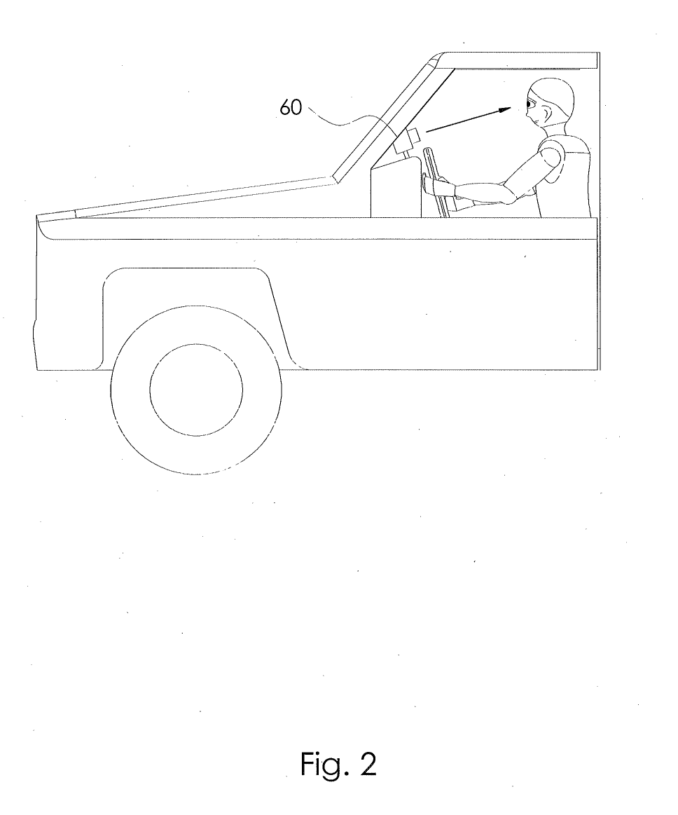

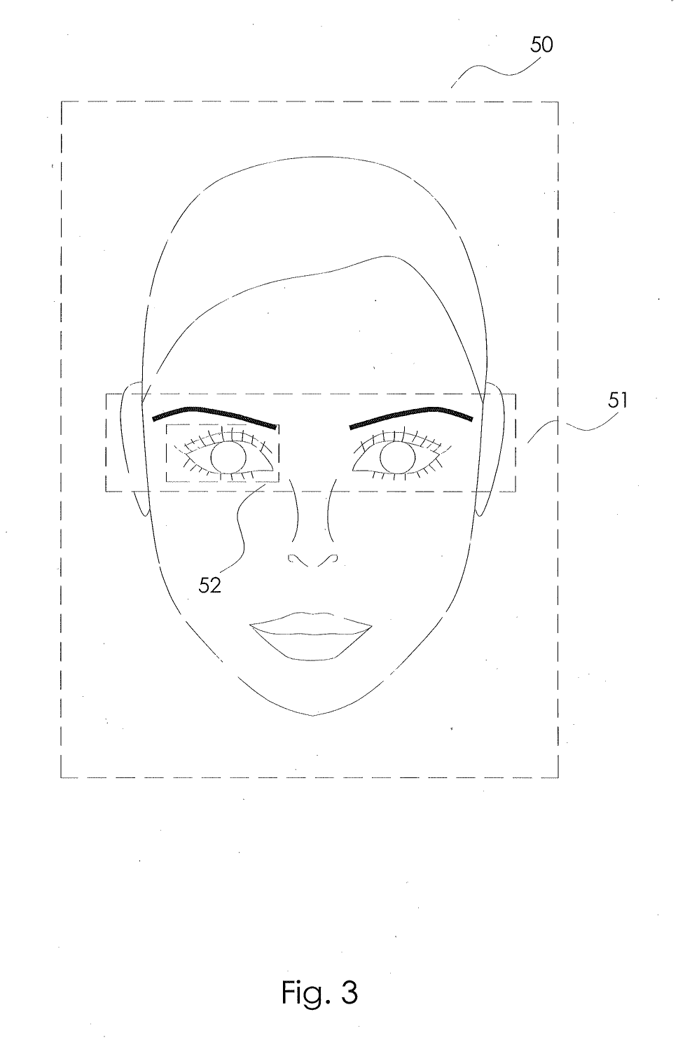

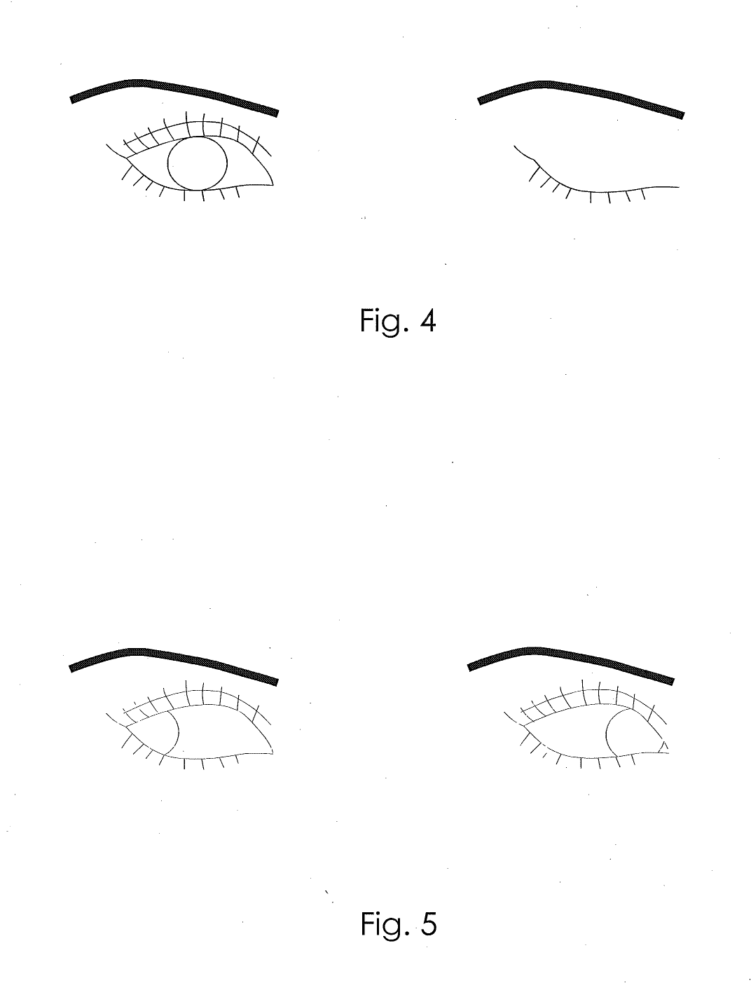

Please refer to FIG. 1 for the system structure of the in-car eye control device of the present invention. The device of the present invention essentially includes a processing unit 10, an image capturing unit 20, and a state feedback unit 30. The image capturing unit 20 is configured for capturing a head image of the user. Preferably, as shown in FIG. 2, the main body 60 of the device is installed above the dashboard so as to obtain a clear head image of the driver. The processing unit 10 includes an image processing unit 11, an eye determination unit 12, a system operation unit 13, and a communication processing unit 14. Referring to FIG. 3 to FIG. 5, the image processing unit 11 performs image processing on the head image 50 and creates an eye searching area 51 within the head image 50. After that, an eye image 52 is defined in the eye searching area 51. By performing operations on the eye image 52, an eye characteristic parameter is obtained. As shown in FIG. 4 and FIG. 5, a blink of the eye, a sidelong glance to the left or to the right, a clockwise or counterclockwise turn of the eye, and other specific eye movements correspond to different eye characteristic parameters respectively. Once the eye characteristic parameter is determined, it is compared with a system control condition to generate an eye control instruction, according to which the system operation unit 13 executes the corresponding system process. As far as in-car equipment is concerned, applicable system processes include playing music, adjusting acoustic volume, controlling the temperature of an air conditioning system, and so on. When it comes to outside-the-car applications, applicable system processes include making a phone call, terminating an incoming phone call, sending out a distress signal, and so forth. The communication processing unit 14 is in charge of communication with people outside the car according to instructions issued by the system operation unit 13. The state feedback unit 30 can send out various alert signals indicating the states of the system, such as whether a system operation is completed or fails and whether a phone call is being made or waiting to be answered.

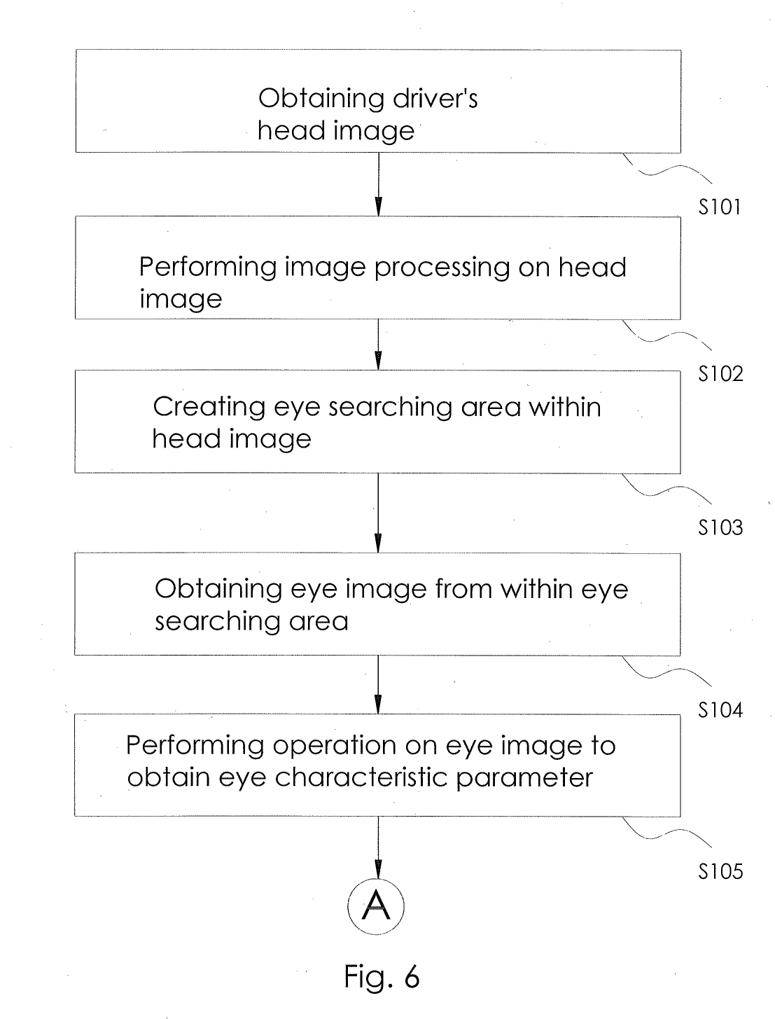

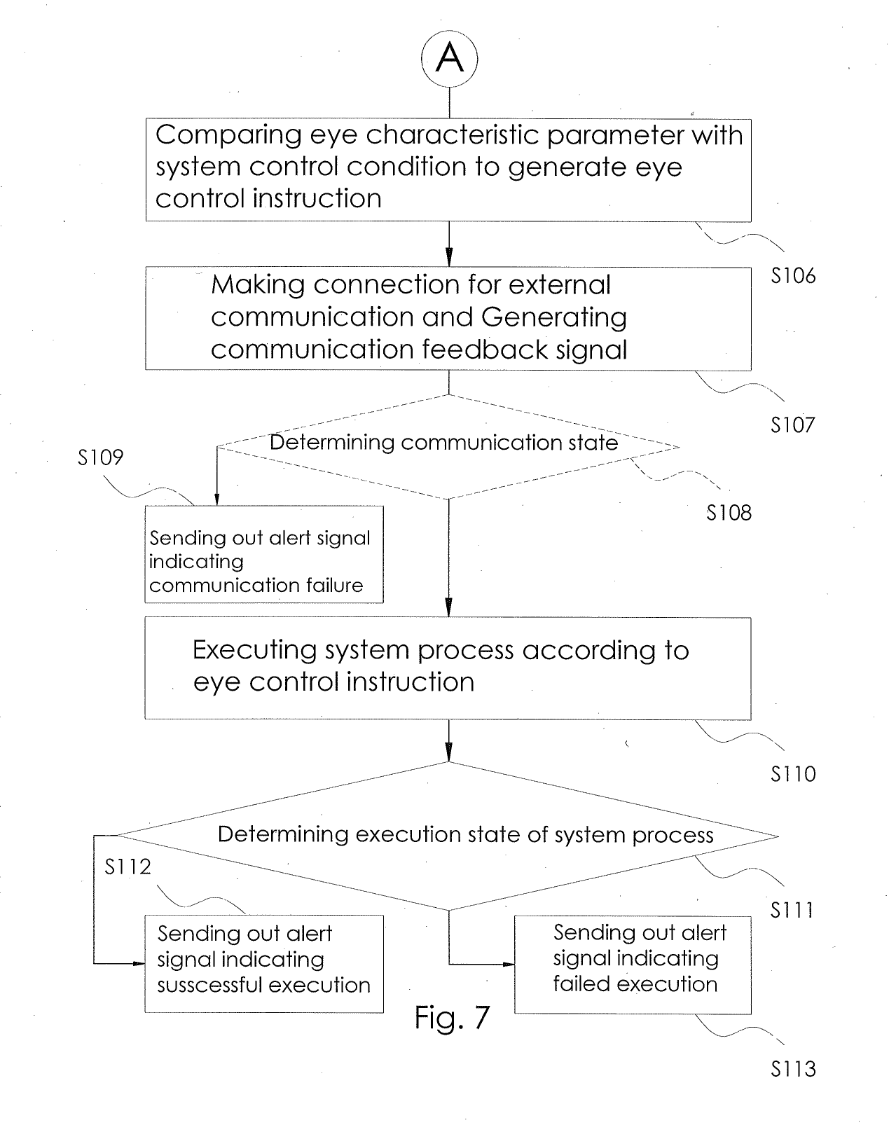

The in-car eye control method of the present invention is now described in detail with reference to FIG. 6 and FIG. 7.

To begin with, a head image of the driver is obtained (S101), and image processing is performed on the head image (S102). After that, an eye searching area is created in the head image (S103), and an eye image is obtained from within the eye searching area (S104). Once the eye image is defined, operations are performed on the eye image to obtain an eye characteristic parameter (S105). The eye characteristic parameter corresponds to the driver's eye movement, such as blinking; glancing leftward, rightward, upward, or downward; and rolling clockwise or counterclockwise. Upon completion of step S105, the eye characteristic parameter is compared with a system control condition to generate an eye control instruction (S106). The system control condition includes a plurality of eye control items to which the driver's different eye movements, such as those mentioned above, correspond respectively. For example, the eye control items include: a left-to-right instruction, a right-to-left instruction, an up-to-down instruction, a down-to-up instruction, and a circling instruction. Based on the eye control items of the system control condition, eye control instructions may have different functions, e.g., to turn on or off a light, to turn on or off music, to increase or decrease acoustic volume, and to turn on or off an air conditioner. In addition to controlling in-car equipment, eye control instructions may serve to communicate with people outside the car, e.g., to make phone calls, to send messages, and to terminate incoming phone calls.

Following step S106, a connection for communication is made, and a communication feedback signal is generated (S107). The communication state can be determined according to the communication feedback signal (S108). If communication with the outside is not available, an alert signal indicating communication failure will be sent (S109) to alert the driver. If communication with the outside is successfully established, the related system process will be executed according to the eye control instruction (S110). It should be pointed out that step S108 is optional, depending on the eye control instruction. If the driver only wishes to control a certain in-car equipment, e.g., to adjust the acoustic volume thereof, then it is not necessary to check the communication state, and step S108 can be omitted. According to the various eye control instructions stated above, the corresponding system processes will be performed to control the intended equipment, e.g., to control the acoustic volume of a radio, to turn on or off an air conditioner, and to make a phone call. Lastly, the execution state of the system process is determined (S111). If the process is properly executed, an alert signal indicating successful execution will be sent out (S112) to inform the driver; otherwise, an alert signal indicating failed execution will be sent out (S113).

The embodiment disclosed above is only the preferred embodiment and is not restrictive of the present invention. A person of ordinary skill in the art may make minor alterations or modifications to the disclosed embodiment without departing from the spirit or scope of the present invention. The scope of the present invention is defined solely by the appended claims.

What is claimed is:

1. An in-car eye control method, allowing a driver of a car to exercise control via a device installed in the car, the in-car eye control method comprising the steps of:
obtaining an eye image of the driver;
performing operations on the eye image to obtain an eye characteristic parameter;
comparing the eye characteristic parameter with a system control condition to generate an eye control instruction; and
executing a system process according to the eye control instruction.

2. The in-car eye control method of claim 1, wherein the eye characteristic parameter corresponds to the driver's eye movement.

3. The in-car eye control method of claim 1, further comprising the steps of:
obtaining a head image of the driver;
performing image processing on the head image;
creating an eye searching area within the head image; and
obtaining the eye image from within the eye searching area.

4. The in-car eye control method of claim 1, wherein the system control condition consists of a plurality of eye control items.

5. The in-car eye control method of claim 4, wherein the eye control items comprise a left-to-right instruction, a right-to-left instruction, an up-to-down instruction, a down-to-up instruction, and a circling instruction.

6. The in-car eye control method of claim 1, wherein the eye control instruction is one selected from the group consisting of a phone call making instruction, a message sending instruction, and an incoming phone call terminating instruction.

7. The in-car eye control method of claim 1, wherein the eye control instruction is one selected from the group consisting of an instruction to turn on a light, an instruction to turn off the light, an instruction to turn on music, an instruction to turn off the music, an instruction to increase acoustic volume, an instruction to decrease the acoustic volume, an instruction to turn on an air conditioner, and an instruction to turn off the air conditioner.

8. The in-car eye control method of claim 1, further comprising the steps of:
determining an execution state of the system process; and
sending out an alert signal indicating successful execution.

9. The in-car eye control method of claim 1, further comprising the steps of:
determining an execution state of the system process; and
sending out an alert signal indicating failed execution.

10. The in-car eye control method of claim 1, further comprising the steps of:
making a connection for communication and generating a communication feedback signal; and
determining a communication state according to the communication feedback signal.
